(19) United States
(12) Patent Application Publication
(10) Pub. No.: US 2010/0332213 A1
(43) Pub. Date: Dec. 30, 2010

(54) DEBUGGING SYSTEM, EMULATOR, AND DEBUGGING METHOD

(75) Inventor: Yuuki OKAMIYA, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: RENESAS ELECTRONICS CORPORATION, Kawasaki (JP)

(21) Appl. No.: 12/827,673

(22) Filed: Jun. 30, 2010

(30) Foreign Application Priority Data
Jun. 30, 2009 (JP) 2009-155228
Jun. 21, 2010 (JP) 2010-140812

(51) Int. Cl. G06F 9/455

(52) U.S. Cl. 703/28; 703/23

(57) ABSTRACT

A debug system includes: a microcomputer mounted on a target system; an emulator configured to execute emulation of the microcomputer based on a user program embedded in the microcomputer; and a computer connected with the emulator in radio communication and configured to instruct start of the emulation and to execute a debugging operation of the microcomputer based on a result of the emulation. The emulator includes: a control section configured to execute the emulation of the microcomputer based on control data from the computer; a radio communication state monitoring section configured to monitor a state of the radio communication between the computer and the emulator when the emulation is performed; and a storage section configured to store substitution control data. The control section acquires the substitution control data from the storage section, when the radio communication is in a non-communicable state, and controls the microcomputer based on the substitution control data such that the target system is set to a predetermined state.

### INCORPORATION BY REFERENCE

This patent application claims priorities on convention based on Japanese Patent Applications No. 2009-155228 filed on Jun. 30, 2009 and No. 2010-140812 filed on Jun. 21, 2010. The disclosure thereof is incorporated herein by reference.

### TECHNICAL FIELD

The present invention generally relates to a debugging system, and in particular to a debugging system executing an on-chip debugging.

### BACKGROUND ART

On-chip debugging is a program development method in which a program embedded in a microcomputer is debugged in a state that the microcomputer is mounted on a target system. Thus, the debugging can be carried out in a state similar to a practical use. In such an on-chip debugging system, a host computer and the microcomputer mounted on the target system are connected by a cable, and the host computer performs the debugging. In this way, a user has to connect a cable and the connected cable per se becomes an obstacle.

Patent Literature 1 discloses a development support system with no signal cable for connecting between a computer and a development support device. FIG. 1 is a block diagram showing a configuration of the development support system disclosed in Patent Literature 1. The development support system disclosed in Patent Literature 1 includes computers 1a to 1n, radio units 2a to 2n and 3a to 3n, development support devices 4a to 4n and target systems 5a to 5n. The target systems 5a to 5n include microcomputers 6a to 6n, respectively. The computers 1a to 1n and the radio units 2a to 2n are respectively connected by cable lines. Also, the radio units 3a to 3n and the development support devices 4a to 4n are respectively connected by cable lines, and the development support devices 4a to 4n and the target systems 5a to 5n are also connected by cable lines, respectively. The radio units 2a to 2n and the radio units 3a to 3n can be wirelessly communicated with each other.

The development support devices 4a to 4n receive programs produced by the computers 1a to 1n, via the radio units 2a to 2n and 3a to 3n. The development support devices 4a to 4n write the programs into the microcomputers 6a to 6n implemented in the target systems 5a to 5n, respectively. The development support devices 4a to 4n perform the operations of the programs written in the microcomputers 6a to 6n and obtain the execution data of the operation results. The development support devices 4a to 4n transmit the execution data to the computers 1a to 1n through the radio units 3a to 3n and 2a to 2n. The computers 1a to 1n debug the programs written in the microcomputers 6a to 6n using the execution data received from the development support devices 4a to 4n.

According to the development support system disclosed in the Patent Literature 1, since the computers 1a to 1n and the development support devices 4a to 4n are connected by wireless communications through the radio units 3a to 3n and 2a to 2n, it is possible to eliminate a labor and time for wiring the signal cables connecting between the computers 1a to 1n and the development support devices 4a to 4n.

### Citation List:

[Patent Literature 1]: JP-A-Heisei 07-319785

### SUMMARY OF THE INVENTION

However, in the development support system of the Patent Literature 1, the computers 1a to 1n communicate in wireless with the development support devices 4a to 4n to control of the operations of the microcomputers 6a to 6n. However, the wireless communication is more unstable than the wire communication. If the wireless communications between the radio units 3a to 3n and the radio units 2a to 2n are in non-communicable states due to various factors such as radio frequency interference, the computers 1a to 1n cannot communicate with the development support devices 4a to 4n. Therefore the control of the microcomputers 6a to 6n becomes impossible.

In an aspect of the present invention, a debug system includes: a microcomputer mounted on a target system; an emulator configured to execute emulation of the microcomputer based on a user program embedded in the microcomputer; and a computer connected with the emulator in radio communication and configured to instruct start of the emulation and to execute a debugging operation of the microcomputer based on a result of the emulation. The emulator includes: a control section configured to execute the emulation of the microcomputer based on control data from the computer; a radio communication state monitoring section configured to monitor a state of the radio communication between the computer and the emulator when the emulation is performed; and a storage section configured to store substitution control data. The control section acquires the substitution control data from the storage section, when the radio communication is in a non-communicable state, and controls the microcomputer based on the substitution control data such that the target system is set to a predetermined state.

In another aspect of the present invention, an emulator which performs emulation of a microcomputer mounted on a target system based on a user program embedded in the microcomputer in response to control data from a computer, and transmits an emulation result to the computer, wherein a radio communication is performed between the emulator and the computer. The emulator includes: a control section configured to execute the emulation of the microcomputer based on control data from the computer; a radio communication state monitoring section configured to monitor a state of the radio communication between the computer and the emulator when the emulation is performed; and a storage section configured to store substitution control data. The control section acquires the substitution control data from the storage section, when the radio communication is in a non-communicable state, and controls the microcomputer based on the substitution control data such that the target system is set to a predetermined state.

In another aspect of the present invention, a debug method is achieved by receiving control data transmitted in a radio communication from a computer by an emulator; by performing emulation of a microcomputer mounted on a target system by the emulator based on a user program embedded in the microcomputer in response to the control data; by transmitting an emulation result of the microcomputer from the emulator to the computer in the radio communication; by monitoring a state of the radio communication between the computer and the emulator; and by controlling the microcomputer by the emulator based on a substitution control data such that the target system is set to a predetermined state, when the radio communication is in a non-communicable state.

In still another aspect of the present invention, a computer-readable recording medium in which a computer-executable program code is stored to attain an emulation control method in an emulator which performs emulation of a microcomputer mounted on a target system in response to a start instruction from a computer, and transmits an emulation result to the computer, wherein a radio communication is performed between the emulator and the computer. The emulation control method is achieved by executing the emulation of the microcomputer based on control data from the computer; by monitoring a state of the radio communication between the computer and the emulator when the emulation is performed; and by controlling the microcomputer by the emulator based on a substitution control data such that the target system is set to a predetermined state, when the radio communication is in a non-communicable state.

According to the present invention, it becomes possible to provide a debugging system capable of appropriately controlling a microcomputer to be debugged even though wireless communications are interrupted between a computer for controlling a debugging and an emulator. Therefore, it can be prevented that the target systems run away out of control due to the microcomputers being out of control.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 is a block diagram showing a configuration of a conventional development support system;

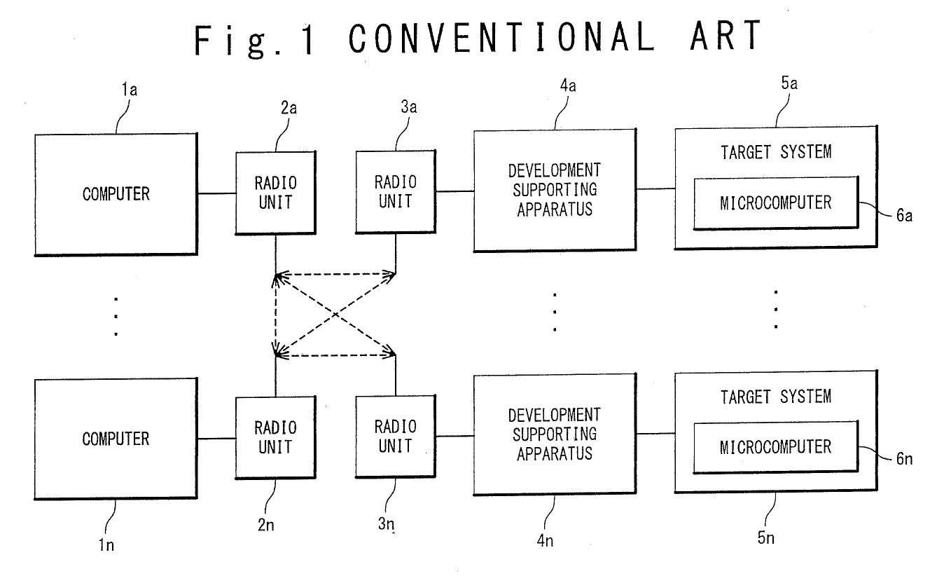

FIG. 2 is a block diagram showing a configuration of a debugging system according to the present invention;

FIG. 3 is a flow chart showing an operation when registering substitution control data 331 according to the present invention; and

FIG. 4 is a flow chart showing an operation of the debugging system according to the present invention.

### DESCRIPTION OF EMBODIMENTS

Hereinafter, a debugging system according to the present invention will be described in detail with reference to the attached drawings.

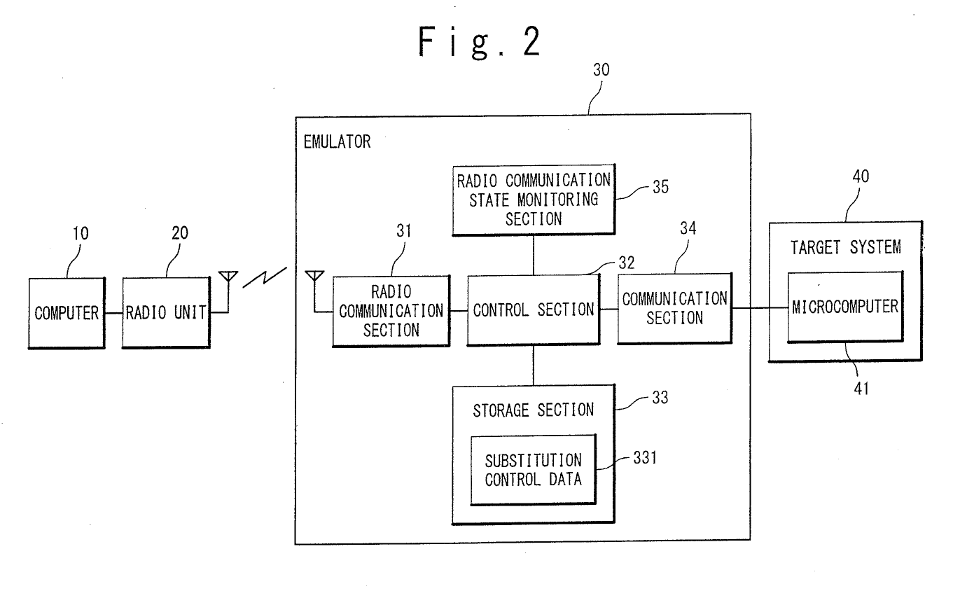

FIG. 2 is a block diagram showing a configuration of the debugging system according to an embodiment of the present invention. Referring to FIG. 2, the debugging system of the present embodiment includes a computer 10, a radio unit 20, an emulator 30 and a target system 40.

The target system 40 includes a microcomputer 41. The target system 40 operates in accordance with the control by the microcomputer 41. The microcomputer 41 is a target to be debugged by the debugging system of the present embodiment. The target system 40 is a device in which the microcomputer 41 is mounted, such as a home-use electric appliance, and an automobile. A program developed in accordance with a function to be performed by the target system 40 is embedded as a user program in the microcomputer 41. In the debugging system of the present invention, the on-chip debugging is performed. Therefore, the user program of the microcomputer 41 is debugged in a state that the microcomputer 41 is mounted on the target system 40. The microcomputer 41 is connected to the emulator 30 and controls the target system 40 based on control signals supplied from the emulator 30.

The computer 10 is a host terminal which performs the debugging of the microcomputer 41. The computer 10 executes a debugger as a software program for the debugging. The computer 10 outputs control data for the debugging operation to the emulator 30 through the radio unit 20 in accordance with user inputs. The control data is a data to make the emulator 30 control the microcomputer 41. For example, the control data includes data such as a user program execution command for the microcomputer 41. The computer 10 is connected to the radio unit 20. The computer 10 performs the debugging operation based on an emulation result received from the emulator 30 through the radio unit 20.

The radio unit 20 is provided with an antenna and performs radio communication with the emulator 30. The radio unit 20 and the emulator 30 communicate with each other by use of a communication system based on such as Zigbee (IEEE802.15.4). It should be noted that the communication system of the radio communication between the radio unit 20 and the emulator 30 is not limited to this example. For example, the radio communication between the radio unit 20 and the emulator 30 may be performed by using a communication system such as a radio LAN (Local Area Network: IEEE802. 11a, b, g, n) or Bluetooth (IEEE802. 15.1). The radio unit 20 is connected to the computer 10 through a USB (Universal Serial Bus) interface. It should be noted that the communication interface between the radio unit 20 and the computer 10 is not limited to this example. For example, LAN (IEEE802. 3) may be used as the communication IF. Further, the radio unit 20 may be incorporated in the computer 10.

The emulator 30 emulates the microcomputer 41. The emulator 30 includes a radio communication section 31, a control section 32, a storage section 33, a communication section 34 and a radio communication state monitoring section 35.

The radio communication section 31 is provided with an antenna and performs radio communication with the radio unit 20. The radio communication section 31 performs a receiving process on a radio signal received from the radio unit 20 in accordance with the communication system and supplies the process result to the control section 32. Moreover, the radio communication section 31 performs a transmitting process on a signal supplied from the control section 32 in accordance with the communication system and transmits the process result to the radio unit 20 through the antenna. It should be noted that the communication system described above may be used as the radio communication system between the radio communication section 31 and the radio unit 20.

The communication section 34 serves as a communication interface to the microcomputer 41. The communication section 34 is connected to the microcomputer 41 and the control section 32 and performs transmission and reception of data.

The storage section 33 stores a program and data for implementing the function of the emulator 30. The storage section 33 includes a ROM (Read Only Memory) and a RAM (Random Access Memory). The storage section 33 is connected to the control section 32 and can transmit and receive data to and from the control section 32.

The storage section 33 stores a substitution control data 331. The substitution control data 331 is a data used for controlling the microcomputer 41 when the radio unit 20 and the radio communication section 31 are in a non-communicable state so that computer 10 cannot control the microcomputer 41 through the emulator 30. The control section 32 of the emulator 30 transmits the substitution control data 331 to the microcomputer 41 through the communication section 34. The microcomputer 41 performs a predetermined control based on the substitution control data such that the target system 40 transits to a predetermined state. Since the microcomputer 41 is mounted in the target system 40 in various application fields, the predetermined control performed in the non-communicable state is determined by the user who develops the user program, and is different in accordance with the target system 40.

The radio communication state monitoring section 35 monitors the radio communication state between the radio communication section 31 and the radio unit 20. Moreover, the radio communication state monitoring section 35 stores a threshold value indicating the radio communication state in advance, and determines whether the radio communication is in the non-communicable state, based on the threshold value. For example, the radio communication state monitoring section 35 determines the radio communication state between the computer 10 and the emulator 30 based on any of the number of times of retransmission data, reception electric field strength of the radio signal and a data error rate between the computer 10 and the emulator 30.

In the present embodiment, the radio communication state monitoring section 35 determines that the radio communication is in the non-communicable state, when the number of times of data retransmission (retry count) in the communication between the control section 32 and the computer 10 is equal to or larger than a predetermined threshold value. That is, in the present embodiment, the non-communicable state of the radio communication implies not only a case that the radio communication between the radio communication section 31 and the radio unit 20 cannot be performed at all, but also a case that the control of the microcomputer 41 through the emulator 30 by the computer 10 is difficult.

The control section 32 performs the emulation of the microcomputer 41 based on the control data supplied from the computer 10 through the radio communication section 31, by executing a program loaded from a recording medium (not shown) and stored in the control section 32. Upon reception of the result of the emulation from the microcomputer 41 through the communication section 34, the control section 32 transmits the emulation result to the computer 10 through the radio communication section 31. In the present embodiment, when the radio communication state monitoring section 35 determines that the radio communication is in the non-communicable state, the control section 32 transmits control signals to the microcomputer 41 based on the substitution control data 331 stored in the storage section 33, in order to control the microcomputer 41.

Next, an example in which the target system 40 is controlled to transit to a predetermined state by use of the radio communication state monitoring section 35 when the radio communication is changed to the non-communicable state. Two states can be considered as the operation of the microcomputer 41 in the debugging operation. One is a case where the radio communication is changed to the non-communicable state during a break state of the execution of the user program, and the other is a case where the radio communication is changed to the non-communicable state during the execution of the user program.

First, a case will be described where the radio communication is changed to the non-communicable state during the break state. In this case, since the user program is not being executed by the microcomputer 41, the target system 40 is held in a state. Therefore, when the radio communication is changed to the non-communicable state, the radio communication section 31 performs the retry of communication with the radio unit 20 in order to recover the radio communication.

Next, the case will be described where the radio communication is changed to the non-communicable state during execution of the user program. In this case, there is a possibility that the target system 40 does not transit to a state that the user desires.

In this way, for a case that the target system 40 does not transit to the desired state by the user, the substitution control data 331 is stored in the storage section 33. The control section 32 reads the substitution control data 331 from the storage section 33 and transmits control signals corresponding to the substitution control data 331 to the microcomputer 41 of the target system 40. Thus, the target system 40 can be changed to the state desired by the user.

Next, the operating method of the debugging system according to the present embodiment will be described below.

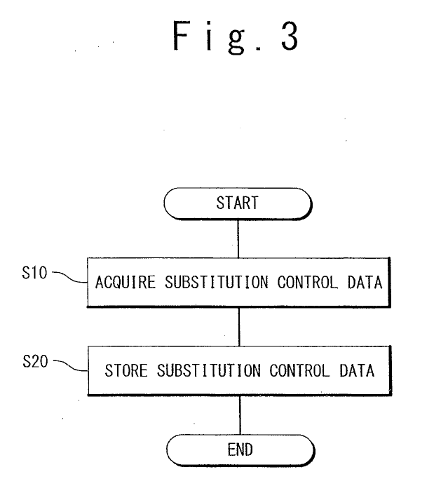

First, a registering operation of the substitution control data 331 according to the present embodiment with reference to FIG. 3. FIG. 3 is a flow chart showing an operation when registering the substitution control data 331 in the present embodiment.

### (Step S10)

The user establishes the radio communication connection between the radio unit 20 and the emulator 30. The user starts the debugger in the computer 10 to perform a debugging operation of the microcomputer 41. The user sets the substitution control data 331 in a setting screen of the debugger. In this operation, the setting of the substitution control data 331 may be performed by the user by selecting selection buttons in a setting screen of the debugger or by inputting a command.

### (Step S20)

Upon completion of inputting the substitution control data 331 to the computer 10, the user inputs a command of writing the substitution control data 331 into the emulator 30. The computer 10 transmits the substitution control data 331 to the emulator 30 through the radio unit 20. The control section 32 in the emulator 30 receives the substitution control data 331 through the radio communication section 31, and stores the substitution control data 331 in the storage section 33.

As described above, the user can set the substitution control data 331 in the emulator 30 before the debugging of the microcomputer 41 is started. The user program of the microcomputer 41 is developed in accordance with the target system 40 on which the microcomputer 41 is mounted. The user can set the control in the non-communicable state in accordance with the target system 40 on which the microcomputer 41 is mounted.

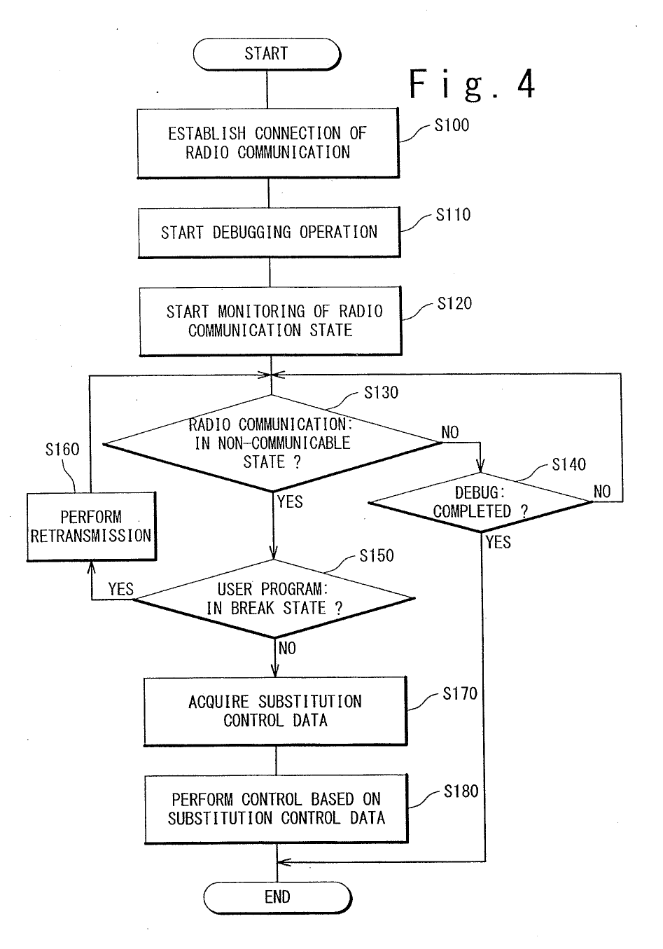

Next, an operating method of the debugging system according to the present embodiment will be described with reference to FIG. 4. It should be noted that in the present embodiment, it is presumed that the radio communication state monitoring section 35 in the emulator 30 determines the radio communication state based on the number of times of the data retransmission (retry count) between the control section 32 and the computer 10 and that a predetermined threshold value is previously set for the determination. Also, it is presumed that the substitution control data 331 stored in the storage section 33 in the emulator 30 is set with the control data for stopping the execution of the user program of the microcomputer 41. It should be noted that the control data of the substitution control data 331 is only an example. The substitution control data may include a data for stopping the user program and a data for shifting the state of the target system 40 to a predetermined state.

### (Step S100)

The communication between the computer 10 and the emulator 30 is connected through the radio communication between the radio unit 20 and the radio communication section 31. The communication section 34 in the emulator 30 and the microcomputer 41 are previously connected.

### (Step S110)

The user instructs start of the debugger. The debugger transmits the control data inputted by the user to the emulator 30 through the radio unit 20. The control section 32 of the emulator 30 receives the control data from the debugger through the radio communication section 31. The control section 32 transmits the control signals to the microcomputer 41 based on the received control data to start the emulation. Thereafter, upon receipt of the execution result of the emulation from the microcomputer 41 at a designated breakpoint of the user program, the control section 32 transmits the execution result to the debugger in the computer 10 through the radio communication section 31. The computer 10 debugs the user program in the microcomputer 41 based on the execution result of the emulation supplied from the emulator 30.

### (Step S120)

When detecting that the emulation of the microcomputer 41 is started by the control section 32, the radio communication state monitoring section 35 in the emulator 30 starts to monitor the radio communication state between the radio communication section 31 and the radio unit 20. In the present embodiment, the radio communication state monitoring section 35 monitors the radio communication state by determining whether or not the number of times of data retransmission in the communication between the control section 32 and the computer 10 exceeds the threshold value for the predetermined retry count.

### (Step S130)

The control section 32 in the emulator 30 continues the emulation of the microcomputer 41 based on the control data from the computer 10. With this operation, the radio communication of the data is performed between the debugger in the computer 10 and the control section 32. The radio communication state monitoring section 35 performs the monitoring while determining whether or not the number of times of data retransmission (retry count) in the communication between the computer 10 and the control section 32 exceeds the threshold value. The radio communication state monitoring section 35 may be adapted to perform the determination at constant time intervals. Alternatively, the determination may be performed every time the data transmission/receipt is performed between the computer 10 and the emulator 30. When the number of times of the data retransmission exceeds the threshold value, it is determined that the radio communication is in the non-communicable state, and the control flow proceeds to Step S150. Whereas, when the number of times of the data retransmission does not exceed the threshold value, it is determined that the radio communication is not in the non-communicable state, and the control flow proceeds to Step S140.

### (Step S140)

The radio communication state monitoring section 35 determines whether or not the debugging operation by the debugger in the computer 10 is completed. The radio communication state monitoring section 35 may detect the completion of the debugging operation when the completion of the emulation is notified by the control section 32. Alternatively, the radio communication state monitoring section 35 may detect the completion of the debugging operation based on the communication contents between the debugger and the control section 32 or through a timeout based on a time lapse from the stop point of the communication. If the debugging operation is not completed, the control flow goes back to the Step S130 and the monitoring operation of the radio communication state is continued. Meanwhile, when the debugging operation is completed, the radio communication state monitoring section 35 ends the monitoring operation of the radio communication state, and thus the present operating method is ended.

### (Step S150)

Upon receipt of the notification of the non-communicable state from the radio communication state monitoring section 35, the control section 32 determines whether or not the user program in the microcomputer 41 is in the break state. The control section 32 determines whether or not the user program is in the break state, based on the communication contents transmitted/received between the computer 10 and the microcomputer 41. When the user program is in the break state, the control flow proceeds to Step S160. Whereas, when the user program is not in the break state, the control flow proceeds to Step S170.

### (Step S160)

When the control section 32 determines that the user program is in the break state, the control section 32 instructs the radio communication section 31 to perform the try. The radio communication section 31 repeats the retry to recover the radio communication. Then, the control flow returns to the step S130. It should be noted that, if the radio communication is not recovered from the non-communicable state, the emulator 30 or the radio unit 20 may generate a predetermined alarm to notify the user.

### (Step S170)

When the control section 32 in the emulator 30 determines that the user program is not in the break state, the control section 32 reads the substitution control data 331 stored in the storage section 33.

### (Step S180)

The control section 32 in the emulator 30 transmits the control signals to the microcomputer 41 based on the substitution control data 331. In response to the control signal from the emulator 30, the microcomputer 41 performs a process corresponding to the control signal to control the target system 40. In the present embodiment, the microcomputer 41 stops the execution of the user program in response to the control signal. Thus, the target system is changed to the predetermined state. Thus, the present operating method is ended.

According to the debugging system of the present embodiment, since the substitution control data 331 is previously stored in the storage section 33 of the emulator 30, the control section 32 in the emulator 30 can appropriately control the microcomputer 41 based on the substitution control data 331 even in the case of the non-communicable state. Since the substitution control data 331 is set to have contents for setting the target system 40 to the predetermined state by the microcomputer 41 in accordance with the target system 40.

Although the present invention has been described in connection with the preferred embodiments thereof referring to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A debug system comprising:
a microcomputer mounted on a target system;
an emulator configured to execute emulation of said microcomputer based on a user program embedded in said microcomputer; and
a computer connected with said emulator in radio communication and configured to instruct start of the emulation and to execute a debugging operation of said microcomputer based on a result of the emulation,
wherein said emulator comprises:
a control section configured to execute the emulation of said microcomputer based on control data from said computer;
a radio communication state monitoring section configured to monitor a state of the radio communication between said computer and said emulator when the emulation is performed; and
a storage section configured to store substitution control data, and
wherein said control section acquires said substitution control data from said storage section, when said radio communication is in a non-communicable state, and controls said microcomputer based on said substitution control data such that said target system is set to a predetermined state.

2. The debugging system according to claim 1, wherein said substitution control data includes a control data to control said microcomputer to stop execution of a user program embedded in said microcomputer for a control of said apparatus, and a control data to control said microcomputer to set said target system to the predetermined state.

3. The debugging system according to claim 1, wherein said control section determines whether or not said microcomputer is executing said user program when it is determined that said radio communication is in the non-communicable state, and controls said microcomputer based on said substitution control data when said user program is being executing.

4. The debugging system according to claim 1, wherein said radio communication state monitoring section determines the state of the radio communication between said computer and said emulator based on one of the number of times of data retransmission, a reception electric field strength of a radio signal, and a data error.

5. An emulator which performs emulation of a microcomputer mounted on a target system based on a user program embedded in said microcomputer in response to control data from a computer, and transmits an emulation result to said computer, wherein a radio communication is performed between said emulator and said computer, said emulator comprising:
a control section configured to execute the emulation of said microcomputer based on control data from said computer;
a radio communication state monitoring section configured to monitor a state of the radio communication between said computer and said emulator when the emulation is performed; and
a storage section configured to store substitution control data,
wherein said control section acquires said substitution control data from said storage section, when said radio communication is in a non-communicable state, and controls said microcomputer based on said substitution control data such that said target system is set to a predetermined state.

6. The emulator according to claim 5, wherein said substitution control data includes a control data to control said microcomputer to stop execution of a user program embedded in said microcomputer for a control of said apparatus, and a control data to control said microcomputer to set said target system to the predetermined state.

7. The emulator according to claim 5, wherein said control section determines whether or not said microcomputer is executing said user program when it is determined that said radio communication is in the non-communicable state, and controls said microcomputer based on said substitution control data when said user program is being executing.

8. The emulator according to claim 5, wherein said radio communication state monitoring section determines the state of the radio communication between said computer and said emulator based on one of the number of times of data retransmission, a reception electric field strength of a radio signal, and a data error.

9. A debug method comprising:
receiving control data transmitted in a radio communication from a computer by an emulator;
performing emulation of a microcomputer mounted on a target system by said emulator based on a user program embedded in said microcomputer in response to said control data;
transmitting an emulation result of said microcomputer from said emulator to said computer in the radio communication;
monitoring a state of the radio communication between said computer and said emulator; and
controlling said microcomputer by said emulator based on a substitution control data such that said target system is set to a predetermined state, when the radio communication is in a non-communicable state.

10. The debugging method according to claim 9, wherein said substitution control data includes a control data to control said microcomputer to stop execution of a user program embedded in said microcomputer for a control of said apparatus, and a control data to control said microcomputer to set said target system to the predetermined state.

11. The debugging method according to claim 9, wherein said monitoring comprises:
determining whether or not said microcomputer is executing said user program when it is determined that said radio communication is in the non-communicable state, and
wherein said controlling comprises:
controlling said microcomputer based on said substitution control data when said user program is being executing.

12. The debugging method according to claim 9, wherein said monitoring comprises:
determining the state of the radio communication between said computer and said emulator based on one of the number of times of data retransmission, a reception electric field strength of a radio signal, and a data error.

13. A computer-readable recording medium in which a computer-executable program code is stored to attain an emulation control method in an emulator which performs emulation of a microcomputer mounted on a target system in response to a start instruction from a computer, and transmits an emulation result to said computer, wherein a radio communication is performed between said emulator and said computer, wherein said emulation control method comprising:
executing the emulation of said microcomputer based on control data from said computer;
monitoring a state of the radio communication between said computer and said emulator when the emulation is performed; and
controlling said microcomputer by said emulator based on a substitution control data such that said target system is set to a predetermined state, when the radio communication is in a non-communicable state.

14. The computer-readable recording medium according to claim 13, wherein said substitution control data includes a control data to control said microcomputer to stop execution of a user program embedded in said microcomputer for a control of said apparatus, and a control data to control said microcomputer to set said target system to the predetermined state.

15. The computer-readable recording medium according to claim 13, wherein said monitoring comprises:
determining whether or not said microcomputer is executing said user program when it is determined that said radio communication is in the non-communicable state, and
wherein said controlling comprises:
controlling said microcomputer based on said substitution control data when said user program is being executing.

16. The computer-readable recording medium according to claim 13, wherein said monitoring comprises:
determining the state of the radio communication between said computer and said emulator based on one of the number of times of data retransmission, a reception electric field strength of a radio signal, and a data error.
